(19) United States
(12) Patent Application Publication
(10) Pub. No.: US 2026/0180482 A1
(43) Pub. Date: Jun. 25, 2026

(54) MOTOR DRIVER CIRCUIT FOR ELECTRIC MOTOR

(71) Applicant: Renesas Design (UK) Limited, Bourne End (GB)

(72) Inventors: Wei-Jen Huang, San Jose, CA (US); Martin Färber, München (DE)

(73) Assignee: Renesas Design (UK) Limited, Bourne End (GB)

(21) Appl. No.: 18/990,360

(22) Filed: Dec. 20, 2024

(51) Int. Cl. H02P 23/04

(52) U.S. Cl. CPC H02P 23/04

(57) ABSTRACT

A motor driver circuit for an electric motor comprising a first node, the motor driver circuit comprising a first resistive shunt device configured to be coupled to the first node.

The present disclosure relates a motor driver circuit for an electric motor.

### BACKGROUND

FIG. 1A is a schematic of a known brushless direct current (BLDC) motor 100. The BLDC motor 100 comprises a rotor 102 and a stator 104. The stator 104 comprises three phase circuits 108, 110, 112. Each of the phase circuits 108, 110, 112 comprises a coil of wire.

As brushless DC motors (BLDC) feature high efficiency and excellent controllability they are widely used in many applications. When these motors operate current typically flows through two of the three coils and the third is in high impedance state as illustrated in FIG. 1A, where the phase circuit 112 is in the high impedance state. In the high impedance state, no current flows through the phase circuit 112. Thus, a tristate node with a parasitic impedance is created and tends to oscillate. The BLDC motor may be a delta BLDC motor 100.

FIG. 1B is an equivalent circuit schematic of the BLDC motor 100 arranged as a typical delta BLDC motor. The BLDC motor 100 comprises the three phase circuits 108, 110, 112 each comprising a coil of wire that may be represented by an inductor having in inductance Lm in series with a resistance Rm. Each phase circuit 108, 110, 112 is coupled to two of the three nodes v0, v1, v2. It will be appreciated that the nodes may be referred to as “pins”.

For each node v0, v1 and v2 a motor driver comprising a half-bridge can drive the adequate voltage to control the current flow through the motor windings represented by the three Lm Rm networks. There is also shown driving patterns 114, 116, 118 for each of the nodes v0, v1, v2.

FIG. 1C is a schematic of the motor network represented by the equivalent circuit model of FIG. 1B, combined with a typical switch network for the three motor phases 108, 110, 112. The switch network comprises the transistors M1, M2, M3, M4, M5, M6.

For example, when the current flow from the node v0 to the node v2 is selected, the transistors M1 and M6 are turned on while the rest of the transistors remains in the off-state. The current path is labelled using reference numeral 120.

With each switching phase, there is one transistor pair that is in the off-state. In this example, both transistors at the node v1 (M3 and M4) remain in off-state. So, they are not providing a current path but creating a parasitic capacitance in series to the inductor-resistor (LR) network. For a current flow from the node v0 to the node v2, there is a parasitic capacitor 122 of the transistor M3, and a parasitic capacitor 124 of the transistor M4.

The transistors M1-M6 may be power field effect transistors (FET). The parasitic capacitances (as represented by the parasitic capacitors 122, 124) may be a result of a gate-drain capacitance (which may be denoted as “Cgd”), a gate-source capacitance (which may be denoted as “Cgs”) and/or a drain-source capacitors (which may be denoted as “Cds”) of the respective power FETs.

FIG. 1D is an equivalent small signal circuit schematic of the motor network and switch network of FIG. 1C for the current path 120 from the node v0 to the node v2. The parasitic capacitance C1 is representative of the parasitic capacitors 122, 124.

The circuit of FIG. 1D also includes a shunt current source 126 to reduce ringing or oscillation. The shunt current source 126 is coupled in series with a switch S0. This illustrates a known technique to address this issue by using a shunt current source connected between the tristate node (the node V1) and ground GND. However, the use of a current source is not very effective for oscillation reduction, consumes a large chip area and adds power dissipation.

### SUMMARY

It is desirable to provide an improved system that mitigates or overcomes one or more of the aforementioned problems.

According to a first aspect of the disclosure there is provided a motor driver circuit for an electric motor comprising a first node, the motor driver circuit comprising a first resistive shunt device configured to be coupled to the first node.

Optionally, the electric motor comprises a plurality of motor phase circuits comprising a first phase circuit coupled to the first node.

Optionally, the electric motor comprises a stator comprising the plurality of motor phase circuits.

Optionally, the electric motor comprises: i) a rotor; or ii) a rotor and a stator; or iii) electric magnets.

Optionally, the electric motor is a direct current (DC) electric motor.

Optionally, the DC electric motor is a brushless DC electric motor.

Optionally, the first resistive shunt device is configured to provide a current flow path from the first node.

Optionally, the current flow path from the first node is to an additional node having a constant voltage or a constant potential.

Optionally, the first resistive shunt device is configured to provide the current flow path from the first node to damp voltage oscillations at the first node.

Optionally, the first resistive shunt device is configured to provide the current flow path from the first node to damp voltage oscillations at the first node when the first node is in a tristate.

Optionally, the first node is in the tristate when the first phase circuit is in a high impedance state.

Optionally, the first resistive shunt device comprises a first shunt device resistive element.

Optionally, the first resistive shunt device comprises a first shunt device switch coupled to the first shunt device resistive element.

Optionally, the first resistive shunt device is coupled to a constant potential.

Optionally, the first resistive shunt device comprises a first active load configured to adapt to voltage oscillations at the first node.

Optionally, the first active load is configured to adapt to voltage oscillations at the first node based on a frequency of the voltage oscillations over device, process, temperature and/or supply voltage corners.

Optionally, the motor driver circuit comprises a switch network configured to switch between different switching states to control the current flow through each of the plurality of motor phase circuits.

Optionally, the switch network comprises a half bridge comprising one or more switch network switches and/or one or more switch network diodes.

Optionally, each of the switch network switches comprises a switch network transistor.

Optionally, each of the switch network transistors comprises at least one transistor and/or each of the switch network transistors comprises one or more diodes.

Optionally, each of the switch network transistors comprises a bipolar transistor, an IGBT and/or a thyristor.

Optionally, each of the switch network transistors comprises a p-type or an n-type MOSFET.

Optionally, the switch network is configured to be coupled to a first voltage rail at a first supply voltage and a second voltage rail at a second supply voltage.

Optionally, the first supply voltage is positive or negative, and the second supply voltage is positive or negative.

Optionally, the first phase circuit comprises a first phase circuit coil having a first coil inductance and a first coil resistance.

Optionally, the first resistive shunt device comprises a first shunt device resistive element, and the resistance of the first shunt device resistive element is greater than the resistance of the first coil resistance.

Optionally, the first resistive shunt device is configured to provide a current flow path from the first node to damp voltage oscillations at the first node, and the resistance of the first shunt device resistive element is sufficient to provide critical damping of the voltage oscillations.

Optionally, the plurality of motor phase circuits comprises a second phase circuit coupled to a second node, and a third phase circuit coupled to a third node.

Optionally, the motor driver circuit comprises a second resistive shunt device configured to be coupled to the second node, and/or a third resistive shunt device configured to be coupled to the third node.

Optionally, the first phase circuit is coupled to the third node, and/or the second phase circuit is coupled to the first node, and/or the third phase circuit is coupled to the second node.

Optionally, the first phase circuit comprises a first phase circuit coil having a first coil inductance and a first coil resistance, the second phase circuit comprises a second phase circuit coil having a second coil inductance and a second coil resistance, and the third phase circuit comprises a third phase circuit coil having a third coil inductance and a third coil resistance.

Optionally, the motor driver circuit comprises a switch network configured to switch between different switching states to control the current flow through each of the plurality of motor phase circuits.

Optionally, the switch network comprises a half bridge comprising one or more switch network switches and/or one or more switch network diodes.

Optionally, the half bridge comprises a first switch network switch configured to be coupled to a first voltage rail and the third node, a second switch network switch configured to be coupled to the third node and a second voltage rail, a third switch network switch configured to be coupled to the first voltage rail and the first node, a fourth switch network switch configured to be coupled to the first node and the second voltage rail, a fifth switch network switch configured to be coupled to the first voltage rail and the second node, and a sixth switch network switch configured to be coupled to the second node and the second voltage rail.

Optionally, the first phase circuit is coupled to the third node, the second phase circuit is coupled to the first node, and the third phase circuit is coupled to the second node.

Optionally, the first resistive shunt device is configured to provide the current flow path from the first node to damp voltage oscillations at the first node when the first node is in a tristate.

Optionally, the first node is in the tristate when the switch network is in a first switching state where current is permitted to flow through one or both of the second and third phase circuits, and current is prevented from flowing through the first phase circuit.

Optionally, the switch network is in the first switching state when the first and sixth switch network switches are in an on state and the second, third, fourth and fifth switch network switches are in an off state.

According to a second aspect of the disclosure there is provided an electric motor apparatus comprising an electric motor comprising a first node, and a motor driver circuit comprising a first resistive shunt device configured to be coupled to the first node.

It will be appreciated that the electric motor of the second aspect may include features set out in relation to the first aspect and may include other features as described herein, in accordance with the understanding of the skilled person.

According to a third aspect of the disclosure there is provided a method of providing a motor driver circuit for an electric motor comprising a first node, the method comprising providing the motor driver circuit comprising a first resistive shunt device configured to be coupled to the first node.

It will be appreciated that the method of the third aspect may include using and/or providing features set out in relation to the first aspect and/or the second aspect and may include other features as described herein, in accordance with the understanding of the skilled person.

### BRIEF DESCRIPTION OF THE DRAWINGS

The disclosure is described in further detail below by example and with reference to the accompanying drawings, in which:

FIG. 1A is a schematic of a known brushless direct current (BLDC) motor, FIG. 1B is an equivalent circuit schematic of the BLDC motor of FIG. 1A, FIG. 1C is a schematic of the motor network represented by the equivalent circuit model of FIG. 1B, combined with a typical switch network for the three motor phases, FIG. 1D is an equivalent small signal circuit schematic of the motor network and switch network of FIG. 1C when one of the nodes is in the tristate;

FIG. 2A is a timing graph showing simulation results for a practical implementation of the motor network and switch network of FIG. 1C, FIG. 2B is a further timing graph showing simulation results for a practical implementation of the motor network and switch network of FIG. 1C;

FIG. 3A is a schematic of a an electric motor and a motor driver circuit in accordance with a first embodiment of the present disclosure, FIG. 3B is a schematic of a specific embodiment of the stator and the motor driver circuit in accordance with a second embodiment of the present disclosure, FIG. 3C is a schematic of an electric motor comprising the stator, and the motor driver circuit 301 in accordance with a third embodiment of the present disclosure, FIG. 3D is an equivalent circuit schematic of the electric motor and the motor driver circuit of FIG. 3C;

FIG. 4A is a schematic of a specific embodiment of the stator and the motor driver circuit in accordance with a fourth embodiment of the present disclosure, FIG. 4B is an equivalent small signal circuit schematic of the motor network and switch network of FIG. 4A; and

FIG. 5A is a timing graph showing simulations results for a practical implementation of the stator and the motor driver circuit of FIG. 4A as part of the electric motor of FIG. 3C, FIG. 5B is a timing graph showing simulations results for a practical implementation of the stator and the motor driver circuit of FIG. 4A as part of the electric motor of FIG. 3C, FIG. 5C is a frequency graph showing the simulation results of FIG. 5B in the frequency domain.

### DETAILED DESCRIPTION

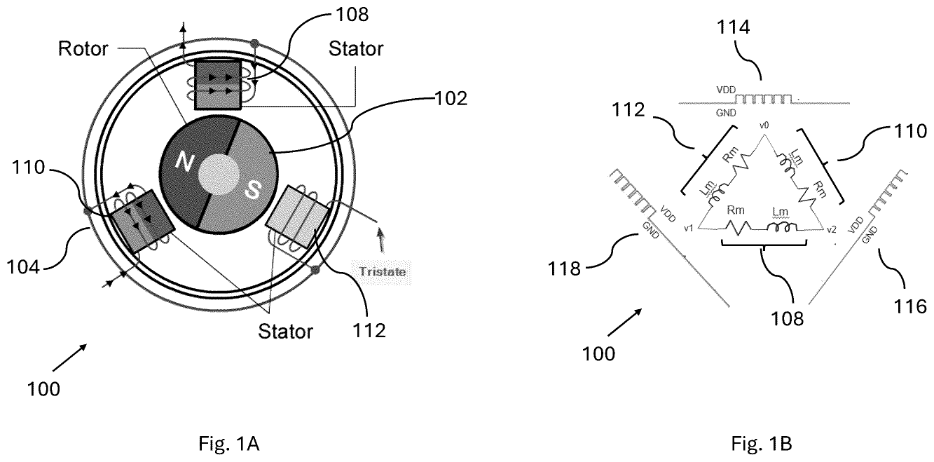

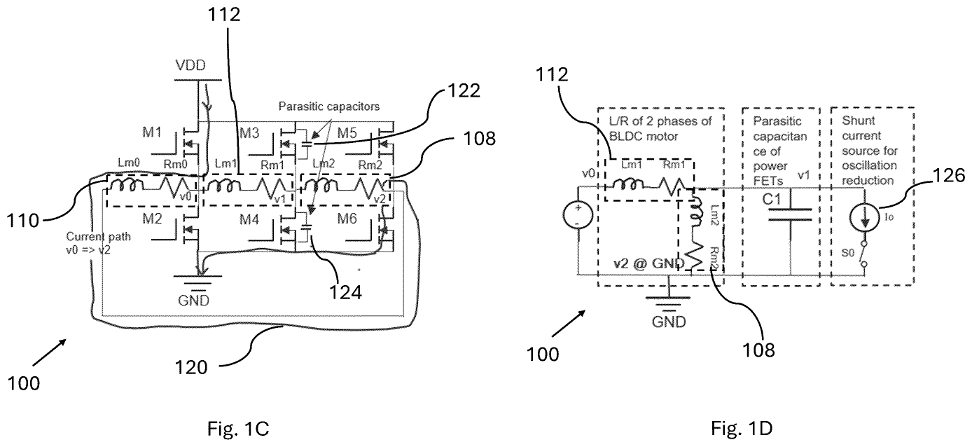

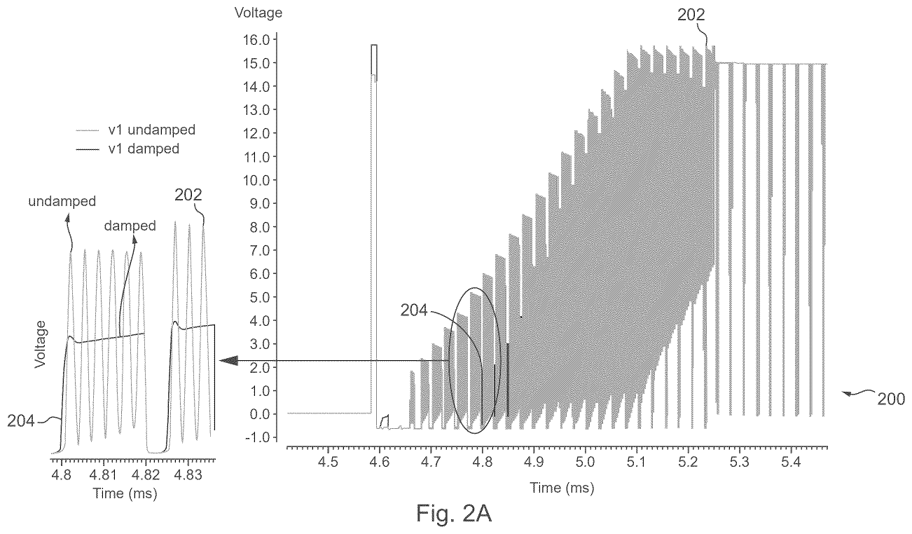

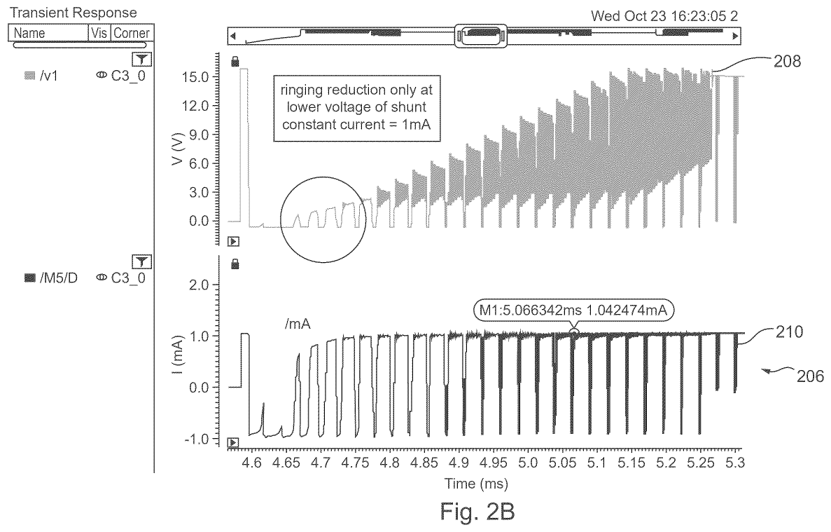

FIG. 2A is a timing graph 200 showing simulation results for a practical implementation of the motor network and switch network of FIG. 1C. There is shown: the voltage at the node v1 when the node v1 is in the tristate region (when the switches are configured as described in relation to FIG. 1C) without the shunt current source 126 (a trace 202) and with the shunt current source (a trace 204). There is a highlighted portion which shows the graph over a different timescale to make clear the difference between the traces 202, 204.

FIG. 2A shows the ringing of node v1 that occurs in the tristate region caused by the parasitic capacitances of the power FETs M3, M4. The trace 204 shows this current damped with the shunt current source 126 functioning as a current source of 1 mA, and the trace 202 shows the undamped case.

It will be appreciated that as the system of FIG. 1C is symmetric, the phase circuits 108, 110, 112 will all behave in approximately the same way such that the traces 202, 204 also demonstrate the behaviour that would occur for the nodes v0 and v2 when they are in the tristate.

FIG. 2B is a further timing graph 206 showing simulation results for a practical implementation of the motor network and switch network of FIG. 1C.

If the voltage pulses have a low amplitude the damping with the shunt current source 126 works well, but if the voltage rises the damping is no longer sufficient and the oscillation may increase drastically.

There is shown the voltage at the node v1 when the node v1 is in the tristate region (when the switches are configured as described in relation to FIG. 1C) with the shunt current source 126 (a trace 208). In the present example, the voltage oscillations have a greater amplitude than as presented in FIG. 2A such that damping provided by the shunt current source 126 is no longer sufficient when the average voltage of node v1 rises and the oscillation increases. A trace 210 shows the current going through the shunt current source 126 during operation. A current higher than needed would lead to higher losses and to an overdamped system at low voltages. A main disadvantage of the known solution of using the shunt current source 126 is that it has limited effectiveness in damping the ringing.

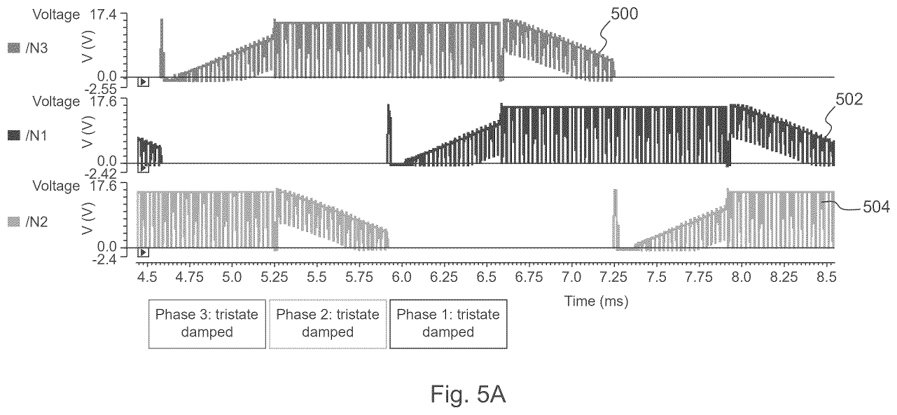

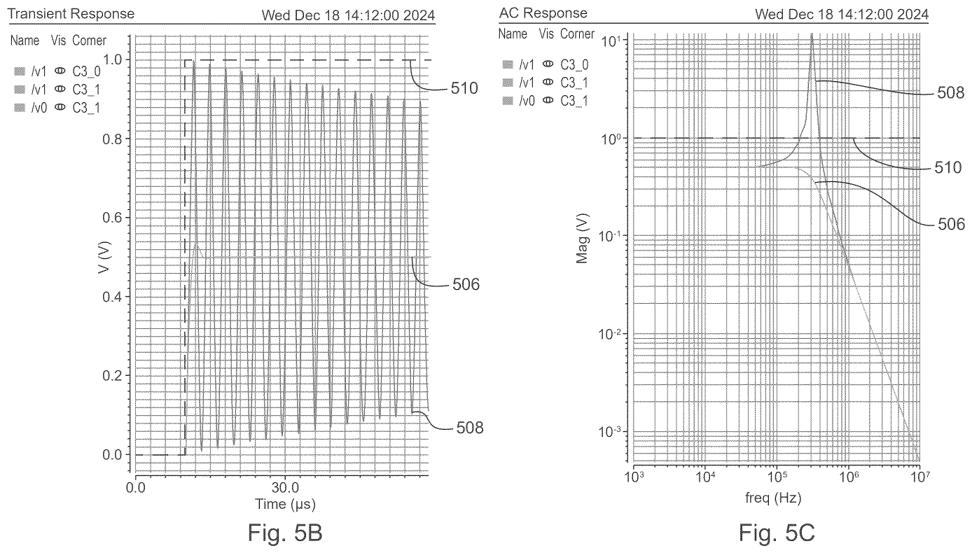

Please note that the magnetic fields may also induce a variable voltage to the node in tristate when the angle of the rotor changes. This variable voltage can be observed in FIG. 2B (for ideal damping) and FIG. 5A. This voltage cannot be derived from the simple equivalent circuit as described previously.

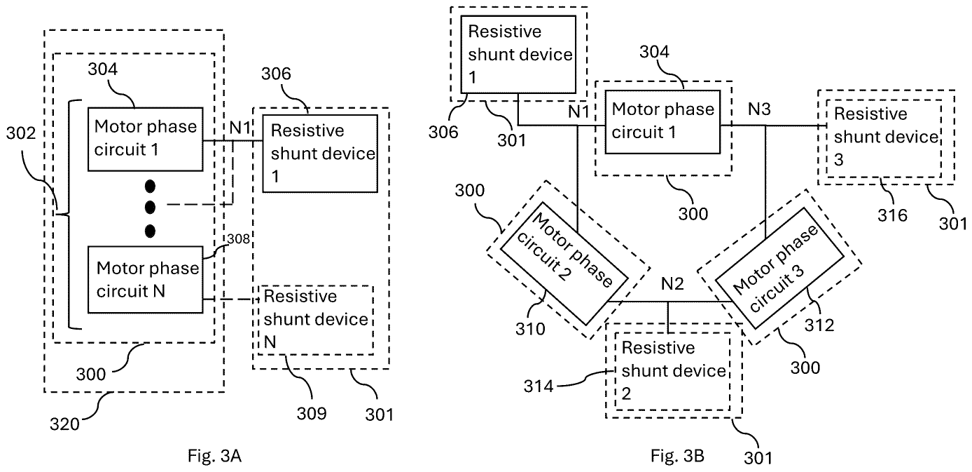

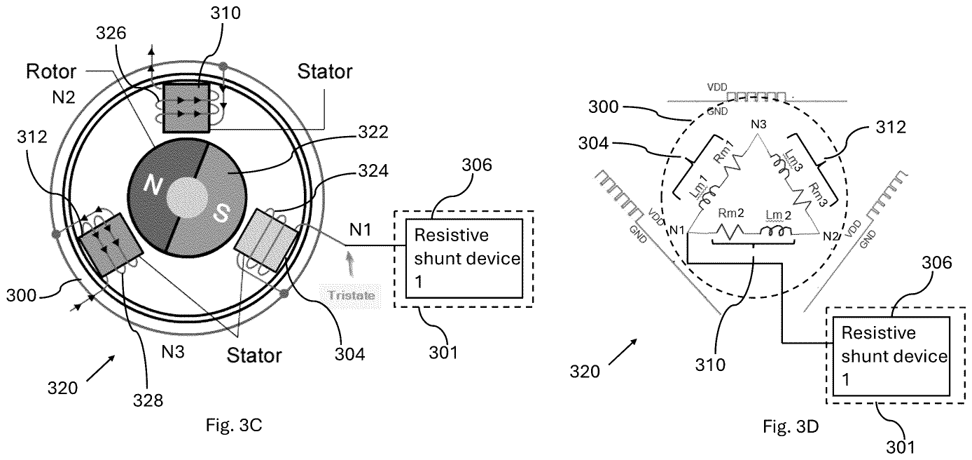

FIG. 3A is a schematic of an electric motor 320 and a motor driver circuit 301 in accordance with a first embodiment of the present disclosure. The electric motor 320 comprises a node N1. The motor driver circuit 301 comprises a resistive shunt device 306 configured to be coupled to the node N1.

The electric motor 320 may comprise a plurality of motor phase circuits 302 comprising a phase circuit 304 coupled to a node N1.

In the present embodiment, the electric motor 320 comprises a stator 300 comprising the plurality of motor phase circuits 302. It will be appreciated that in further embodiments, the electric motor 320 may comprise a rotor or both a rotor and a stator. In a further embodiment, the electric motor 320 may comprise electric magnets where, for example, the electric motor 320 is a linear motor.

The motor drive circuit 301 may drive the operation of the electric motor by driving an adequate voltage to control the current flow through each of the phase circuits 302. The motor driver circuit 301 may receive control signals, for example from a controller, and drive the operation of the electric motor based on the received control signals.

In the present example, the plurality of phase circuits 302 comprises an N-th phase circuit 308 to illustrate that specific embodiments of the present disclosure may comprise any number of phase circuits 302 in accordance with the understanding of the skilled person. “N” denotes an integer, as is conventional notation.

The motor driver circuit 301 may comprise a resistive shunt device for each of the plurality of phases 302. In the present example this is illustrated by an N-th resistive shunt device 309 coupled to a node of the N-th phase circuit 308.

The stator 300 may be used with a direct current (DC) electric motor, such as the brushless DC (BLDC) electric motor as illustrated in FIG. 1A-1D.

The phase circuit 304 may, for example, comprise a phase circuit coil having a coil inductance and a coil resistance.

The resistive shunt device 306 may be configured to provide a current flow path from the node N1. Specifically, the resistive shunt device 306 may provide a resistive current path.

The resistive shunt device 306 may provide the current flow path from the node N1 to damp the voltage oscillation at the node N1 which may occur when the node N1 is in the tristate. The node N1 may be in the tristate when the phase circuits 304 and 310 are in a high impedance state. The phase circuits 304 and 310 may be in the high impedance state when the stator 300 is configured such that current cannot flow through the phase circuit312.

Whilst the phase circuits 304 and 310 are in the high impedance state, the stator 300 may be configured such that current can flow through one or more of the other phase circuits of the plurality of phase circuits 302.

FIG. 3B is a schematic of a specific embodiment of the stator 300 and the motor driver circuit 301 in accordance with a second embodiment of the present disclosure.

In the present embodiment, the plurality of phase circuits 302 further comprises a phase circuit 310 coupled to a node N2 and a phase circuit 312 coupled to a node N3. It will be appreciated that further embodiments of the stator 300 may comprise one or more further phase circuits.

The motor driver circuit 301 may comprise a resistive shunt device 314 configured to be coupled to the node N2, which may be used to prevent oscillations at the node N2 when, for example, the node N2 is in the tristate.

The resistive shunt device 314 may function substantially as described for the resistive shunt device 306 but in relation to the node N2, rather than the node N1, in accordance with the understanding of the skilled person.

In further specific embodiments, the resistive shunt device 314 may be implemented as described for any of the embodiments of the resistive shunt device 306 as described herein, in accordance with the understanding of the skilled person.

The motor driver circuit 301 may comprise a resistive shunt device 316 configured to be coupled to the node N3, which may be used to prevent oscillations at the node N3 when, for example, the node N3 is in the tristate.

The resistive shunt device 316 may function substantially as described for the resistive shunt device 306 but in relation to the node N3, rather than the node N1, in accordance with the understanding of the skilled person.

In further specific embodiments, the resistive shunt device 316 may be implemented as described for any of the embodiments of the resistive shunt device 306 as described herein, in accordance with the understanding of the skilled person.

It will be appreciated that in further embodiments where the plurality of phase circuits 302 comprises additional phase circuits, each of the one or more of the additional phase circuits may also be coupled to a resistive shunt device of the motor driver circuit 301 that may be implemented in accordance with any of the embodiments of the resistive shunt device 306 as described herein, and in accordance with the understanding of the skilled person.

The phase circuit 304 may be coupled between the node N1 and the node N3. The phase circuit 310 may be coupled between the node N1 and the node N2. The phase circuit 312 may be coupled between the node N2 and the node N3.

FIG. 3C is a schematic of the electric motor 320 comprising the stator 300, and the motor driver circuit 301 in accordance with a third embodiment of the present disclosure. It will be appreciated that in further embodiments the stator 300 of the present embodiment may be implemented using any of the stator 300 embodiments described herein. It will be appreciated that in further embodiments the motor driver circuit 301 of the present embodiment may be implemented using any of the motor driver circuit 301 embodiments described herein. The electric motor 320 further comprises a rotor 322.

It will be appreciated that in a specific embodiment the motor driver circuit 301 may be coupled to each of the nodes N1, N2, N3 to drive the operation of the electric motor 320.

The electric motor 320 may function substantially as described for the motor 100, but with the inclusion of the motor driver circuit 301 of the present disclosure providing improved performance of the system when voltage oscillations occur, for example, on a tristate node.

It will be appreciated that further embodiments of the present disclosure may include other types of motors with phase circuits that can be represented by an RL circuit (or similar) that are subject to ringing with a fixed time constant, having the motor driver circuit 301 of the present disclosure with the resistive shunt device 306 to reduce oscillations.

For example, and as discussed previously, the electric motor 320 may comprise a rotor and/or a stator. In specific embodiments, one or both of the rotor and the stator may comprise a plurality of phase circuits that are subject to ringing/oscillations.

In a further embodiment, the electric motor 320 may comprise electric magnets where, for example, the electric motor 320 is a linear motor. In a specific embodiment, the electric magnets may comprise a plurality of phase circuits that are subject to ringing/oscillations.

FIG. 3D is an equivalent circuit schematic of the electric motor 320 and the motor driver circuit 301 of FIG. 3C.

The phase circuit 304 may comprise a phase circuit coil 324 having a coil inductance Lm1 and a coil resistance Rm1, as represented by the inductor Lm1 and resistor Rm1 coupled in series in the equivalent circuit model of FIG. 3C.

The phase circuit 310 may comprise a phase circuit coil 326 having a coil inductance Lm2 and a coil resistance Rm2, as represented by the inductor Lm2 and resistor Rm2 coupled in series in the equivalent circuit model of FIG. 3C.

The phase circuit 312 may comprise a phase circuit coil 328 having a coil inductance Lm3 and a coil resistance Rm3, as represented by the inductor Lm3 and resistor Rm3 coupled in series in the equivalent circuit model of FIG. 3C.

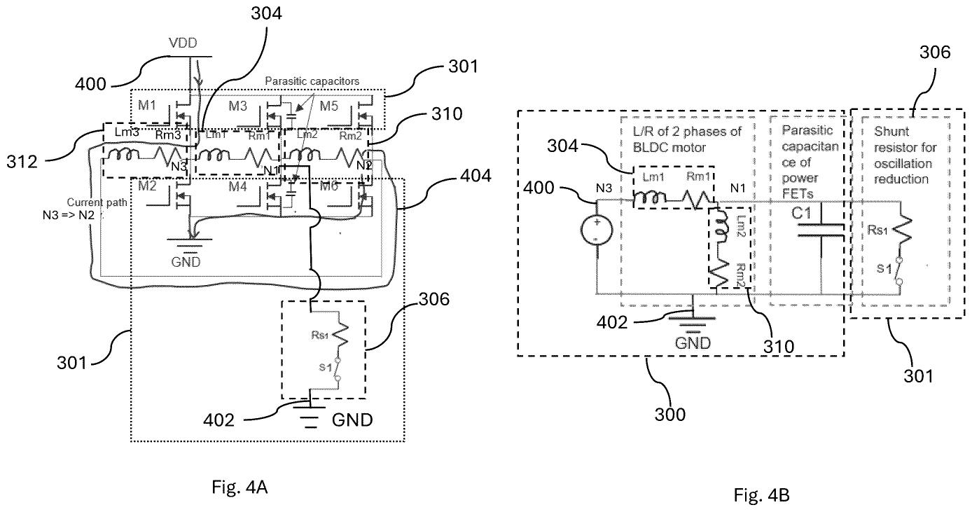

FIG. 4A is a schematic of a specific embodiment of the stator 300 and the motor driver circuit 301 in accordance with a fourth embodiment of the present disclosure.

In the present embodiment, the resistive shunt device 306 comprises a shunt device resistive element Rs1. The shunt device resistive element Rs1 may be a resistor. The shunt device 306 may further comprises a switch s1 coupled to the shunt device resistive element Rs1. The resistive shunt device 306 may be coupled to GND, but in further embodiments, the resistive shunt device 306 may be coupled to a different constant potential, such as the supply voltage VDD. In the present example, the constant potential coupled to the resistive shunt device 306 is ground GND.

It will be appreciated that the shunt device resistive element Rs1 may be referred to as the shunt resistor Rs1 when the shunt device resistive element is the shunt resistor.

In specific embodiments, the shunt resistor Rs1 may be coupled (for example via the switch s1) to GND, but in further embodiments, the shunt resistor Rs1 may be coupled to a different constant potential such as the supply voltage VDD. The potential changes the losses in the resistor Rs1 but not the time constant of the damping circuit.

In an alternative embodiment, the resistive shunt device 306 may comprise an active load that is configured to adapt to voltage oscillations at the node N1. The active load may be configured to adapt to voltage oscillations at the node N1 based on a frequency of the voltage oscillations over device, process, temperature and/or supply voltage corners.

The motor driver circuit 301 may further comprise a switch network configured to switch between different switching states to control the current flow through each of the plurality of motor phase circuits 304, 310, 312. The switch network may comprise a half bridge comprising one or more switch network switches and/or one or more switch network diodes. In the present example, the half bridge comprises switch network switches, where each switch network switch comprises a switch network transistor M1, M2, M3, M4, M5, M6. In the present example there is a first switch network transistor pair formed by transistors M1 and M2; a second switch network transistor pair formed by transistors M3 and M4; and a third switch network transistor pair formed by transistor M5 and M6.

The stator 300 functions substantially as described for the circuit presented in FIG. 1C but with the inclusion of the resistive shunt device 306 for mitigating the issue of voltage oscillations.

In the present example, the switch network transistors M1-M6 each comprise n-type MOSFETs. However, it will be appreciated that in further embodiments, the switch network transistors M1-M6 may comprise p-type MOSFETs.

In further embodiments each of the switch network transistors M1-M6 may comprise at least one transistor. In further embodiments each of the switch network transistors M1-M6 may comprise one or more diodes. In further embodiments, each of the switch network transistors M1-M6 may comprise a bipolar transistor, an IGBT and/or a thyristor.

The motor driver circuit 301 may be configured to be coupled to a voltage rail 400 at a supply voltage VDD and a voltage rail 402 at a supply voltage GND, which is ground.

In specific embodiments, the voltage rail 400 may be at a positive or negative supply voltage. In specific embodiments, the voltage rail 402 may be at a positive or a negative supply voltage.

For example, the resistive shunt device 306 may be used for motor bridges with a positive and a negative supply rail, for example, +/−VDD, where VDD is the supply voltage. In this case the shunt resistor Rs1 may dissipate less energy, as the ground GND is the midpoint.

The resistance of the shunt device resistive element Rs1 may be greater than the resistance of the coil resistance Rm1. Preferably, the damping resistor resistance (provided by the shunt device resistive element Rs1) is significantly greater than the parasitic resistance of the winding (the coil resistance Rs1). Otherwise, there may be extreme power losses.

The resistive shunt device 306 may be configured to provide a current flow path from the node N1 to damp voltage oscillations at the node N1, for example, when the node is in the tristate, as discussed previously. The resistance of the shunt device resistive element Rs1 may be sufficient to provide critical damping of the voltage oscillations.

In the present embodiment the switch network transistor M1 is coupled to the voltage rail 400 and the node N3; the switch network transistor M2 is coupled to the node N3 and the voltage rail 402; the switch network transistor M3 is coupled to the voltage rail 400 and the node N1; the switch network transistor M4 is coupled to the node N1 and the voltage rail 402; the switch network transistor M5 is coupled to the voltage rail 400 and the node N2; and the switch network transistor M6 is coupled to the node N2 and the voltage rail 402.

In the present embodiment, the phase circuit 304 is coupled to the node N3; the phase circuit 310 is coupled to the node N1; and the phase circuit 312 is coupled to the node N2.

As discussed previously, the resistive shunt device 306 may be configured to provide the current flow path from the node N1 to damp voltage oscillations at the node N1 when the node N1 is in the tristate.

The node N1 may be in the tristate when the switch network is in a switching state where current is permitted to flow through one or both of the phase circuits 310, 312, and current is prevented from flowing through the phase circuit 304, such that the phase circuit 304 is in a high impedance state.

In the present example, the switching network is in the switching state where the node N1 is in the tristate when the switch network transistors M1, M6 are in an on state and the switch network transistors M2-M5 are in an off state.

In this switching state, where the current flow from the node N3 to the node N2 is selected, the transistors M1 and M6 are turned on while the rest of the transistors remain in the off-state. The current path is labelled using reference numeral 404.

FIG. 4B is an equivalent small signal circuit schematic of the motor network and switch network of FIG. 4A for the current path 404 from the node N3 to the node N2. The parasitic capacitance C1 is representative of the parasitic capacitors of the switch network transistors M3, M4.

Instead of using a shunt current source (for example as shown in FIG. 1D), embodiments of the present disclosure use a resistive shunt device. In the present example, the resistive shunt device 306 comprises the shunt device resistive element Rs1 which is a shunt resistor.

In specific embodiments, there is provided improved damping of the ringing and lower power consumption than the known shunt current source technique, as the shunt resistance of the shunt device resistive element Rs1 is much larger than the resistance Rm1 of the motor winding. Furthermore, the shunt device resistive element Rs1 is simple and small to implement.

It will be appreciated that the switch s1 is optional, and in a specific embodiment the switch s1 can be used to enable the damping function provided by the shunt device resistive element Rs1 only when the motor is on and the node N1 is in tristate.

It will be appreciated that in further embodiments the order of the switch s1 and the shunt device resistive element Rs1 may be exchanged, and in further embodiments the shunt device resistive element Rs1 may be split into two or more parts with the switch s1 being placed between resistive elements parts.

FIG. 5A is a timing graph showing simulations results for a practical implementation of the stator 300 and motor driver circuit 301 of FIG. 4A as part of the electric motor 320 of FIG. 3C having a resistive shunt device for each of the phase circuits 304, 310, 312. For example, the stator 300 may be arranged as shown in FIG. 3B with the resistive shunt device 306 coupled to the node N1, the resistive shunt device 314 coupled to the node N2, and the resistive shunt device 316 coupled to the node N3.

There is shown: the voltage at the node N3 (a trace 500), the voltage at the node N1 (a trace 502), and the voltage at the node N2 (a trace 504). FIG. 5A shows the terminal voltages of the electric motor 320 with ideal damping. FIG. 5A shows the voltage at the three terminals N1, N2, N3 when in tristate, steadily connected to ground or pulsed.

The following describes the detailed implementation of the specific embodiment of the stator 300 and the motor driver circuit 301 of FIG. 4A as part of the electric motor 320 of FIG. 3C having a resistive shunt device for each of the phase circuits 304, 310, 312, for any of the phase circuits 304, 310, 312 being in the tristate.

The following equations and description are written for the node N1 being in the tristate. However, it will be appreciated that the following equations and description are also applicable to the other nodes N2, N3 when they are in the tristate during operation of the electric motor 320.

For now, we assume that the motor 320 does not induce any voltages and that the node N1 does not depend on the angle of the rotor 322.

The variables used in the formulas are:
V3: Motor driver switching node N3 voltage-either VDD or zero
V1: Motor driver tri-state node N1 voltage
Lm1: Equivalent inductance of each the phase circuit 304.
Rm1: Equivalent resistance of the phase circuit 304.
C: Parasitic capacitance of both switches M3, M4 at the node N1 in tristate (labelled as C1 in FIG. 4B).
Rs: Resistance of the shunt resistor Rs1 to reduce or eliminate the voltage oscillation at the node N1.

The transfer function is:

$$\frac{V 1}{V 3} = \frac{1}{Lm 1 \times C \times {s}^{2} + ( \frac{Lm 1}{Rs} + Rm 1 \times C ) s + ( \frac{Rm 1}{Rs} + 2 )} \qquad ( 1 )$$

At direct current (DC) s tends to zero (s=>0):

$$\frac{V 1}{V 3} = \frac{Rs}{Rm 1 + 2 Rs} \qquad ( 2 )$$

In order to keep the amplitude unchanged: Rs>>Rm1:

$$\frac{V 1}{V 3} = \frac{1}{2} \qquad ( 3 )$$

Re-write equation with ω₀ the system natural frequency is (still assuming Rs>>Rm1):

$${ω}_{0} = \frac{1}{\sqrt{0.5 \times Lm 1 \times C}} \qquad ( 4 )$$

$$Therefore :$$

$$\frac{V 1}{V 3} = \frac{1}{2} \frac{{ω}_{0}^{2}}{{s}^{2} + ( \frac{1}{RsC} + \frac{Rm 1}{Lm 1} ) s + {ω}_{0}^{2}} \qquad ( 5 )$$

The damping ratio:

$$ζ = \frac{1}{2 {ω}_{0}} ( \frac{1}{RsC} + \frac{Rm 1}{Lm 1} ) \qquad ( 6 )$$

1) 0<ζ<1: (underdamped system): the system oscillates before settling down to the final value.
2) ζ=1: (critically damped system): The system reaches its final value without oscillation.
3) ζ>1: (overdamped system): the system does not exhibit oscillations. The step response is slower.

In the present example, the resistance Rs of the shunt resistor Rs1 is preferably 2.5 kΩ to obtain a critically damped system.

FIG. 5B is a timing graph showing simulations results for a practical implementation of the stator 300 and the motor driver circuit 301 of FIG. 4A as part of the electric motor 320 of FIG. 3C showing the voltage at the node N1 in the time domain. The simulation results show a step response.

There is shown: the voltage at the node N1 when the resistance Rs of the shunt resistor Rs1 is 2.5 kΩ (a trace 506) and the voltage at the node N1 when the resistance Rs of the shunt resistor Rs1 is 1 MΩ (a trace 508). There is also shown the voltage at the node N3 (a trace 510).

FIG. 5C is a frequency graph showing the simulation results of FIG. 5B in the frequency domain. The same labelling for the traces 506, 508 is used in the present graph.

For the trace 506, the oscillation and the peak in the AC response are gone. For comparison the trace 508 was simulated with 1 MΩ which effectively functions as an open circuit.

For the shunt constant current source, the equivalent resistance would be larger when VDD is higher, since V/I=R, and R varies with V. So, for the damping factor in equation (6) there will be a decrease as Rs increases due to a VDD increase. Finally, the reduction effect gets less, and oscillation starts for higher voltages.

If a higher current is chosen, we have an overdamped system at low voltages leading to the aforementioned slower response and a higher current consumption. Therefore, embodiments of the present disclosure using a resistive shunt device overcomes issues with known systems using a shunt current source.

Known systems such as those presented in FIG. 1A-1D have the following disadvantages:
1. Not very effective for ringing or oscillation reduction, especially for higher voltage. (Current source does not provide a constant RC-value over voltage range)
2. More current consumption for current source as additional current is needed to generate the constant currents at the nodes v0, v1, v2
3. More area for building current mirror for shunt current sources required.
4. A reference current is needed.

Embodiments of the present disclosure have the following advantages:
1. Using resistors as a shunt device is more effective over the whole voltage range.
2. No additional current for bias current generation and current mirroring is needed. The known system used multiple current mirrors to obtain a multiplier from currents in the range of micro amperes from a central bias block to the range of milli amperes.
3. Less area needed to build the circuit.

Embodiments of the present disclosure may give the same reduction of ringing for all VDD range (for a BLDC controller: VDD from 3V to 26.4V) and for a variable voltage at the node in tristate which is depending on the angle of the rotor. The current implementation provided good results for the voltage range VDD from 3V to 26.4V.

Furthermore, no extra current consumption in mirrors is needed and less area will be used.
1. The ringing or oscillation for a motor pin being in tristate when one end is switching as BLDC motor is rotating will be almost removed. This is the case for the whole voltage range; even over corners it will be drastically reduced.
2. No additional current consumption (no need to build additional current mirror) is seen when this function is enabled.

In summary, embodiments of the present disclosure may reduce the ringing/oscillation due to parasitic capacitances of the node in tristate and the inductance of the BLDC (brushless DC) motor more effectively than known systems.

Various improvements and modifications may be made to the above without departing from the scope of the disclosure.

1. A motor driver circuit for an electric motor comprising a first node, the motor driver circuit comprising a first resistive shunt device configured to be coupled to the first node.

2. The motor driver circuit of claim 1, wherein the electric motor comprises:
a plurality of motor phase circuits comprising:
a first phase circuit coupled to the first node.

3. The motor driver circuit of claim 2, wherein the electric motor comprises a stator comprising the plurality of motor phase circuits.

4. The motor driver circuit of claim 1, wherein the electric motor comprises:
i) a rotor; or
ii) a rotor and a stator; or
iii) electric magnets.

5. The motor driver circuit of claim 1, wherein the electric motor is a brushless direct current (BLDC) electric motor.

6. The motor driver circuit of claim 1, wherein the first resistive shunt device is configured to provide a current flow path from the first node.

7. The motor driver circuit of claim 6, wherein the current flow path from the first node is to an additional node having a constant voltage or a constant potential.

8. The motor driver circuit of claim 6, wherein the first resistive shunt device is configured to provide the current flow path from the first node to damp voltage oscillations at the first node.

9. The motor driver circuit of claim 8, wherein the first resistive shunt device is configured to provide the current flow path from the first node to damp voltage oscillations at the first node when the first node is in a tristate.

10. The motor driver circuit of claim 1, wherein the first resistive shunt device comprises a first shunt device resistive element.

11. The motor driver circuit of claim 3, wherein the first resistive shunt device comprises a first shunt device switch coupled to the first shunt device resistive element.

12. The motor driver circuit of claim 1, wherein the first resistive shunt device comprises a first active load configured to adapt to voltage oscillations at the first node.

13. The motor driver circuit of claim 2 comprising a switch network configured to switch between different switching states to control the current flow through each of the plurality of motor phase circuits.

14. The motor driver circuit of claim 13, wherein the switch network comprises a half bridge comprising one or more switch network switches and/or one or more switch network diodes.

15. The motor driver circuit of claim 2, wherein the first phase circuit comprises a first phase circuit coil having a first coil inductance and a first coil resistance.

16. The motor driver circuit of claim 15, wherein:
the first resistive shunt device comprises a first shunt device resistive element; and
the resistance of the first shunt device resistive element is greater than the resistance of the first coil resistance.

17. The motor driver circuit of claim 16, wherein:
the first resistive shunt device is configured to provide a current flow path from the first node to damp voltage oscillations at the first node; and
the resistance of the first shunt device resistive element is sufficient to provide critical damping of the voltage oscillations.

18. The motor driver circuit of claim 2, wherein the plurality of motor phase circuits comprises:
a second phase circuit coupled to a second node; and
a third phase circuit coupled to a third node.

19. The motor driver circuit of claim 18, comprising:
a second resistive shunt device configured to be coupled to the second node; and/or
a third resistive shunt device configured to be coupled to the third node.

20. The motor driver circuit of claim 18 comprising a switch network configured to switch between different switching states to control the current flow through each of the plurality of motor phase circuits.

21. The motor driver circuit of claim 20, wherein the switch network comprises a half bridge comprising one or more switch network switches and/or one or more switch network diodes.

22. The motor driver circuit of claim 21, wherein the half bridge comprises:
a first switch network switch configured to be coupled to a first voltage rail and the third node;
a second switch network switch configured to be coupled to the third node and a second voltage rail;
a third switch network switch configured to be coupled to the first voltage rail and the first node;
a fourth switch network switch configured to be coupled to the first node and the second voltage rail;
a fifth switch network switch configured to be coupled to the first voltage rail and the second node; and
a sixth switch network switch configured to be coupled to the second node and the second voltage rail.

23. The motor driver circuit of claim 22, wherein:
the first phase circuit is coupled to the third node;
the second phase circuit is coupled to the first node; and
the third phase circuit is coupled to the second node.

24. An electric motor apparatus comprising:
an electric motor comprising a first node; and
a motor driver circuit comprising a first resistive shunt device configured to be coupled to the first node.

25. A method of providing a motor driver circuit for an electric motor comprising a first node, the method comprising providing the motor driver circuit comprising a first resistive shunt device configured to be coupled to the first node.
